(19) United States
(12) Patent Application Publication
(10) Pub. No.: US 2004/0101208 A1
(43) Pub. Date: May 27, 2004

(54) Apparatus and methods for averaging image signals in a media processor

(75) Inventors: Rodger M. Hopkins, Warrenton, VA (US); Joseph C. Brown, Lovettsville, VA (US); Brian J. Loch, Sterling, VA (US); Edward W. Bindon, Fairfax, VA (US)

Correspondence Address: Finnegan, Henderson, Farabow,, Garrett & Dunner, L.L.P., 1300 I Street, N.W., Washington, DC, 20005-3315, US

(73) Assignee: VIDAR Systems Corporation

(21) Appl. No.: 10/304,962

(22) Filed: Nov. 27, 2002

(51) Int. Cl. G06T 5/50; H04N 1/409

(52) U.S. Cl. 382/275; 358/447; 358/463; 358/1.9

(57) ABSTRACT

A first signal and a second signal are obtained using a first and second image sensors, respectively. The first signal and the second signal are converted from analog to digital form. The first signal and the second signal are then averaged to improve the signal to noise ratio of the resulting signal. The first signal may be obtained using a channel corresponding to a first channel. The second signal may be obtained using a channel corresponding to a second channel. Further, a third signal may also be obtained using a channel corresponding to a third channel. Then, the first, second, and third signals may be averaged to generate an averaged signal.

### BACKGROUND OF THE INVENTION

I. Field of the Invention

The present invention generally relates to the field of media processors, such as scanners and film digitizers. More particularly, the invention relates to apparatus and methods for averaging image signals in a media processor.

II. Background and Relevant Information

Typically, media processors, such as scanners/digitizers used for scanning X-ray films, use one panchromatic sensor to obtain a monochromatic signal. Scanning monochromatic images using only one channel results in several problems.

These problems include, for example, a higher likelihood of a random noise on the one channel corrupting the scanned image. Accordingly, there is a need for improved methods and apparatus for scanning images using scanners, such as film digitizers.

### SUMMARY OF THE INVENTION

Apparatus and methods consistent with embodiments of the present invention improve signal to noise ratio of a signal, for example, in a media processor, such as a film digitizer or a scanner.

According to one embodiment of the invention, a method for improving signal to noise ratio is provided. The method may include obtaining a first signal at a first time instant corresponding to a position on a sheet of media and storing the first signal at a first memory location. The method may also include obtaining a second signal at a second time instant corresponding to the position on the sheet of media, wherein the second time instant is different from the first time instant. Also, the method may include storing the second signal at a second memory location. Additionally, the method may include averaging the first stored signal and the second stored signal to generate an averaged signal.

According to another embodiment of the invention, a method for improving signal to noise ratio of a grayscale signal in a digitizer having an image sensor array comprising a first channel, a second channel, and a third channel. The method may include acquiring a first grayscale signal at a first time instant on the first channel corresponding to at least one pixel area. The method may further include storing the first grayscale signal. Also, the method may include acquiring a second grayscale signal at a second time instant on the second channel corresponding to the at least one pixel area and storing the second grayscale signal. The method may further include acquiring a third grayscale signal at a third time instant on the third channel corresponding to the at least one pixel area and storing the third grayscale signal. Additionally, the method may include averaging the first grayscale signal, the second grayscale signal, and the third grayscale signal to generate another grayscale signal.

According to yet another embodiment of the invention, an apparatus for improving image quality of an image may include an image sensor for obtaining a first grayscale signal on a red color channel, a second grayscale signal on a green color channel, and a third grayscale signal on a blue color channel corresponding to a pixel area on a sheet of media. The apparatus may further include a first analog to digital converter for converting the first grayscale signal to a first digital value. Also, the apparatus may include a second analog to digital converter for converting the second grayscale signal to a second digital value. Further, the apparatus may include a third analog to digital converter for converting the third grayscale signal to a third digital value. Additionally, the apparatus may include a digital signal processor for averaging the first digital value, the second digital value, and the third digital value to produce an average digital value corresponding to the pixel area on the sheet of media.

According to still another embodiment of the invention, an apparatus for improving the image quality of an X-ray film image is provided. The apparatus may comprise a panchromatic sensor array for obtaining a first grayscale signal, a second grayscale signal, and a third grayscale signal corresponding to a pixel area on a sheet of media. The apparatus may further comprise a first analog to digital converter for converting the first grayscale signal to a first digital value. Also, the apparatus may include a second analog to digital converter for converting the second grayscale signal to a second digital value. Further, the apparatus may include a third analog to digital converter for converting the third grayscale signal to a third digital value. Additionally, the apparatus may include a digital signal processor for averaging the first digital value, the second digital value, and the third digital value to produce an average digital value corresponding to the pixel area on the sheet of media.

Both the foregoing general description and the following detailed description are exemplary and are intended to provide further illustration and explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment consistent with embodiments of the present invention;

FIG. 2 shows an exemplary media processor consistent with embodiments of the present invention;

FIG. 3 shows an exemplary image sensor array and image processing system consistent with embodiments of the present invention;

FIG. 4A shows an exemplary arrangement of red, green, and blue channels consistent with embodiments of the present invention;

FIG. 4B shows additional aspects of the exemplary image processing system of FIG. 2 consistent with embodiments of the present invention;

FIG. 5 shows additional aspects of the exemplary image processing system of FIG. 2 consistent with embodiments of the present invention;

FIG. 6 shows a flowchart of an exemplary method for improving signal to noise ratio consistent with embodiments of the present invention; and

FIG. 7 shows a flowchart of another exemplary method for improving signal to noise ratio of a grayscale signal in a digitizer consistent with embodiments of the present invention.

### DETAILED DESCRIPTION

Apparatus and methods consistent with embodiments of the present invention improve signal to noise ratio of a signal, for example, in a media processor, such as a film digitizer or a scanner.

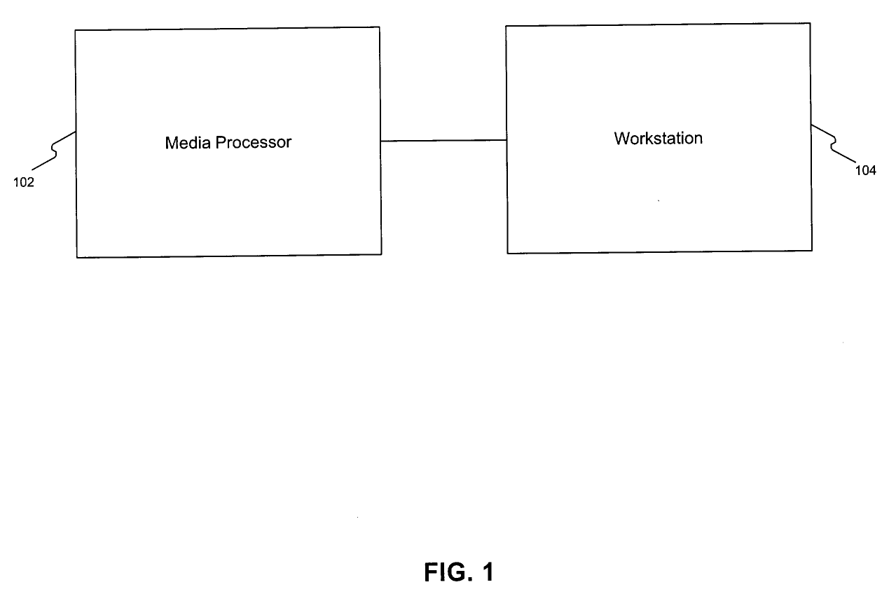

FIG. 1 illustrates an exemplary system environment consistent with embodiments of the present invention. As shown the exemplary system environment may include a media processor 102 operably connected to a workstation 104. Media processor 102 may be a film digitizer, a scanner, or any other type of digitizing/scanning apparatus which may be used to scan and/or digitize an X-ray film, a sheet of paper, a sheet of transparency, or a sheet of photographic paper. Workstation 104 may be any computer, such as a personal computer. Also, although media processor 102 and workstation 104 are shown as separate components, they may be combined in one device. Thus, for example, a user may scan an X-ray film using a media processor and may view the scanned image on the media processor, as opposed to on a display associated with the workstation.

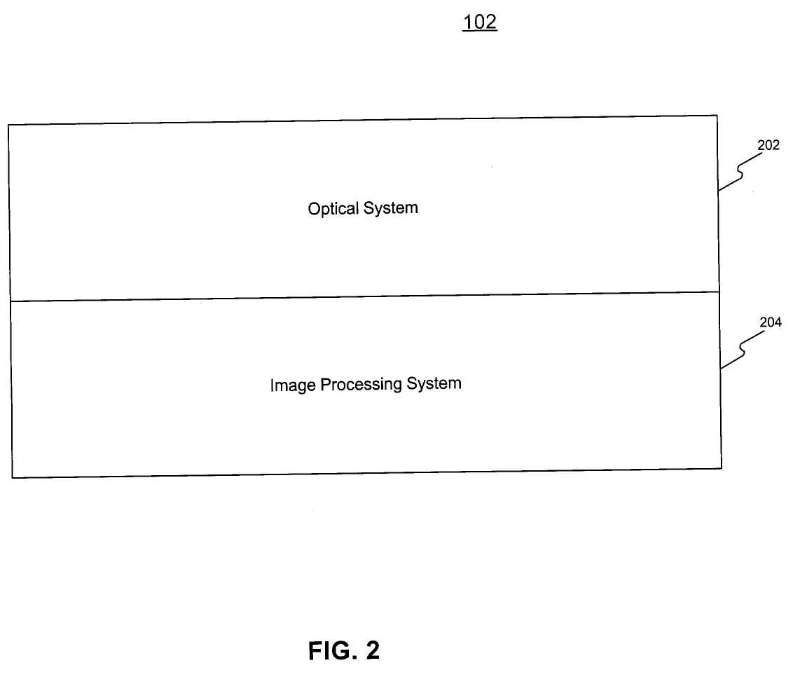

FIG. 2 shows an exemplary media processor (102 of FIG. 1) consistent with embodiments of the present invention. The exemplary media processor 102 may comprise an optical system 202 and an image processing system 204. Image processing system 204 may include image sensors and additional components for processing of an image. Optical system 202 may further comprise a light source and lens elements to focus a ray of light from the light source onto the image sensors, for example.

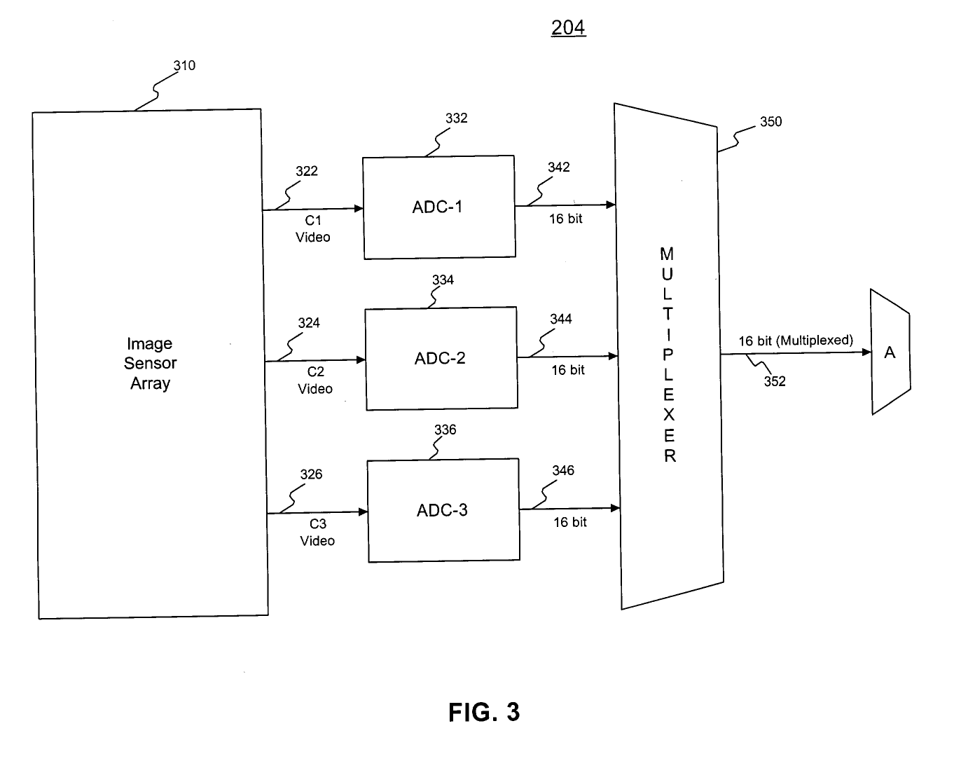

FIG. 3 shows an exemplary image processing system 204 consistent with embodiments of the present invention. Image processing system 204 may include an image sensor array 310. Image sensor array 310 may include columns of sensors for sensing a data value corresponding to, for example, a pixel area on a sheet of media. In one embodiment, each column of sensors may be used to acquire a set of grayscale or panchromatic values. Image sensors consistent with the present invention include a charge-coupled device (“CCD”) sensor, a complementary metal-oxide semiconductor (“CMOS”) sensor, or any other sensor that may be used to sense, for example, a value corresponding to the intensity of a pixel area on a sheet of media. In one embodiment, image sensor array 310 may comprise a first channel for obtaining a first grayscale signal 322 (C1 Video), a second channel for obtaining a second grayscale signal 324 (C2 Video), and a third channel for obtaining a third grayscale signal 326 (C3 Video). Although FIG. 3 depicts only three channels for obtaining the various grayscale signals, fewer or additional channels may also be used to obtain fewer or additional grayscale signals.

In another embodiment, each column of sensors may be used to sense a particular color component, for example. Thus, the first channel may correspond to a channel for obtaining a red color signal, the second channel may correspond to a channel for obtaining a blue color signal, and the third channel may correspond to a channel for obtaining a green color signal.

Referring FIG. 3, in one embodiment, image processing system 204 may further include a first analog to digital converter 332, a second analog to digital converter 334, and a third analog to digital converter 336. First analog to digital converter 332 may convert first grayscale signal 322 to a first digital value 342. Second analog to digital converter 334 may convert second grayscale signal 324 to a second digital value 344. Third analog to digital converter 336 may convert third grayscale signal 326 to a third digital value 346. Although FIG. 3 depicts separate analog to digital converters, the separate analog to digital converters may be combined into one component.

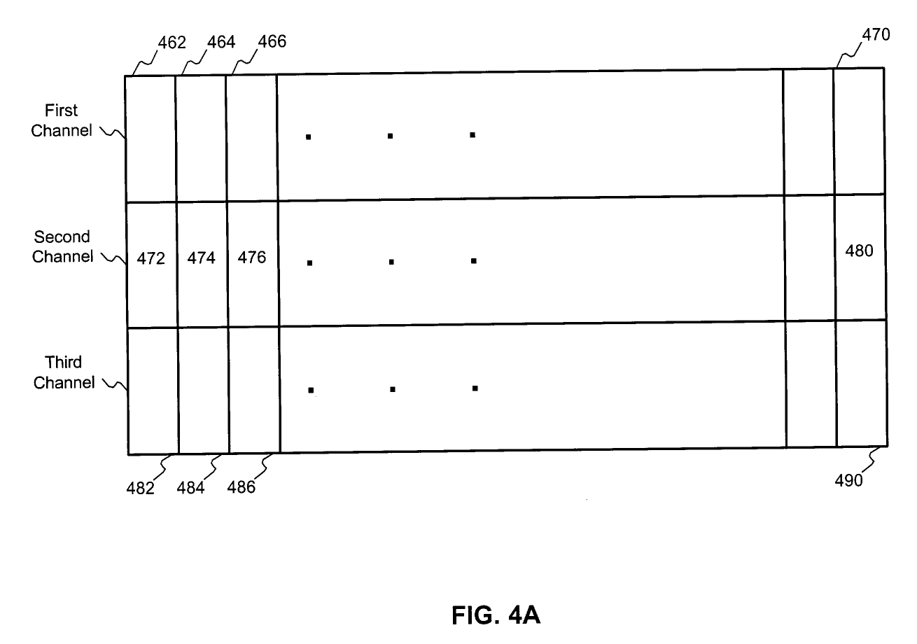

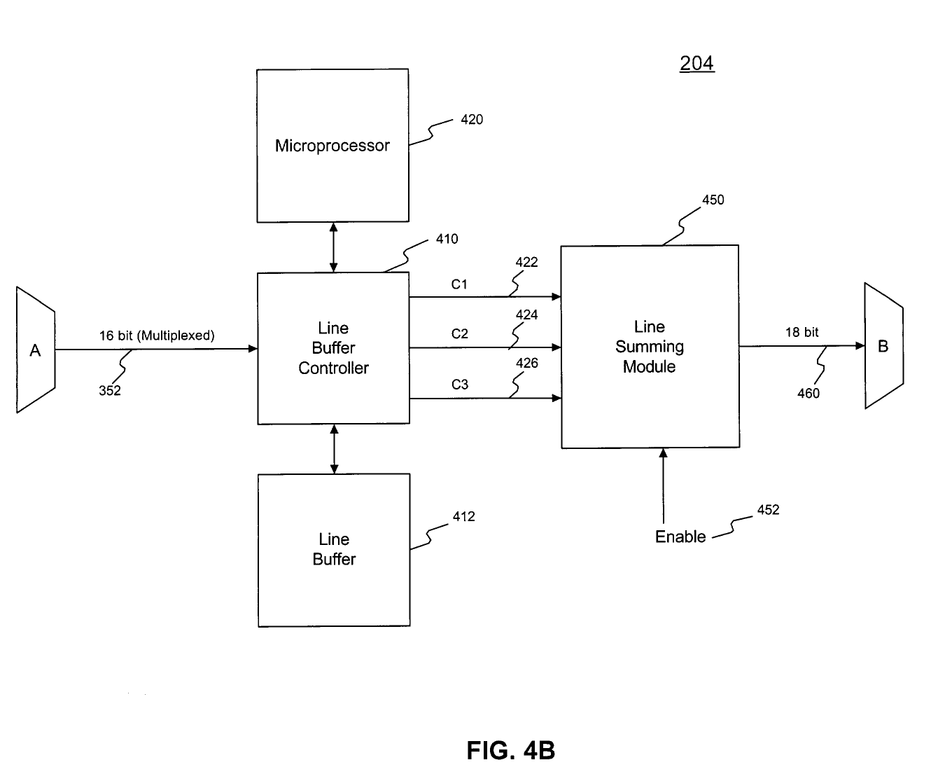

Referring now to FIG. 4A, an exemplary arrangement of a first channel, a second channel, and a third channel, consistent with embodiments of the present invention, is shown. In one embodiment, the first channel may comprise several image sensor elements 462, 464, 466, and 470 arranged in a row. Similarly, the second channel may comprise image sensor elements 472, 474, 476, and 480. Also, the third channel may comprise image sensor elements 482, 484, 486, and 490. In one embodiment, a color image sensor array may have each image sensor element corresponding to red, green, and blue channels unmasked, such that each image sensor element may obtain a grayscale signal corresponding to a pixel area on a sheet of media. Alternatively, neutral density filters may be placed on image sensor elements corresponding to the red, green, and blue channels to obtain grayscale signals. Although FIG. 4A shows only three channels, an image sensor array consistent with the present invention may have fewer or more channels. Also, each channel may be separated by a certain number of lines. Additionally, each channel may comprise thousands of image sensor elements arranged in a row or a column.

Referring to FIG. 3, image processing system 204 may further include a multiplexer 350. Multiplexer 350 may be used to multiplex first digital value 342, second digital value 344, and third digital value 346 into a 16 bit (multiplexed) signal 352. Although FIG. 3 shows a multiplexer, one may not use a multiplexer and instead all three digital values may be transmitted on separate channels to the next component of image processing system 204.

FIG. 4B shows additional aspects of the exemplary image processing system 204 of FIG. 2 consistent with embodiments of the present invention. As shown in FIG. 4A, the multiplexed signal 352 may be received by a line buffer controller 410. Line buffer controller 410 may control a line buffer 412, which may be used to store digital values corresponding to at least one line or column of pixel areas. Line buffer controller 410 may also interact with a microprocessor 420, which may be responsible for coordinating and controlling the various components of a media processor. In one embodiment, line buffer controller may output digital values corresponding to the first channel, the second channel, and the third channel, respectively, on channels C1 422, C2 424, and C3 426. These digital values then may be added using a line summing module 450 upon receipt of an enable 452 signal. Line summing module 450 may generate an 18 bit signal 460, which is a sum of the incoming signals. One skilled in the art will appreciate that each incoming signal may be represented using any number of bits and the line summing module may generate a corresponding sum. In other words, 18 bit signal 460 is merely exemplary and the sum of the incoming signals may have more or less bits.

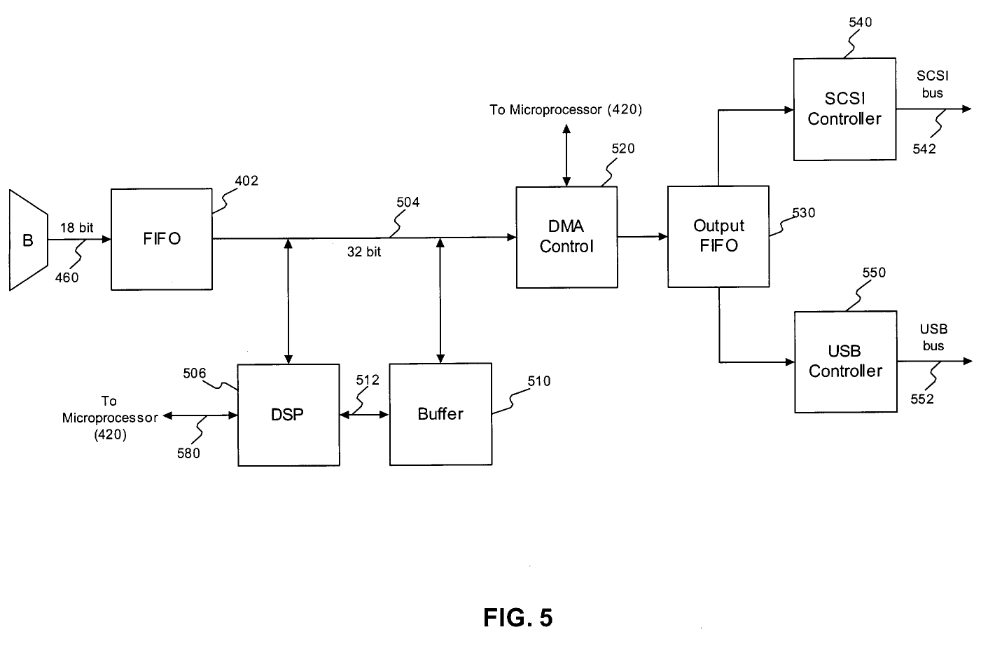

FIG. 5 shows additional aspects of the exemplary image processing system 204 of FIG. 2 consistent with embodiments of the present invention. Thus, for example, the 18 bit signal may be clocked into a First in First Out (“FIFO”) 402 buffer or memory. Subsequently, FIFO 402 may output a 32 bit signal on a bus 504. A digital signal processor (“DSP”) 506 may be connected to bus 504. As used herein the term “digital signal processor” is not limited to processor used specifically in digital signal processing applications, rather it includes other types of processors as well, such as microprocessors, micro-controllers, or any other signal processing devices. DSP 506 may also be connected to microprocessor 420 via an interface 580. Also, DSP 506 may be connected to a buffer 510 via an interface 512. DSP 506 may include circuitry to generate an average of the first grayscale signal, the second grayscale signal, and the third grayscale signal. Although FIG. 5 depicts hardware modules for performing calculations, one may use software alone or in combination with the hardware modules to average the signals, for example.

In one embodiment, a DMA control 520 may output the averaged grayscale signal to an output FIFO 530. Also, DMA control 520 may be connected to microprocessor 420 to ensure there are no conflicts in accessing the bus 504, for example. The averaged grayscale signal may then be output by output FIFO 530 to a Small Computer Systems Interface (“SCSI”) controller 540 and/or a Universal Serial Bus (“USB”) controller 550. SCSI controller 540 may then output the averaged grayscale signal to a SCSI bus 542. USB controller 550 may output the averaged grayscale signal onto a USB bus 552. SCSI bus 542 may be connected to a SCSI hard disk (not shown), for example, which may used to store image data corresponding to a sheet of media. Similarly, USB bus 552 may be connected to USB compatible storage devices, which could be used to store image data corresponding to a sheet of media, for example. Of course, other types of controllers and bus structures may also be used consistent with the embodiments of the present invention.

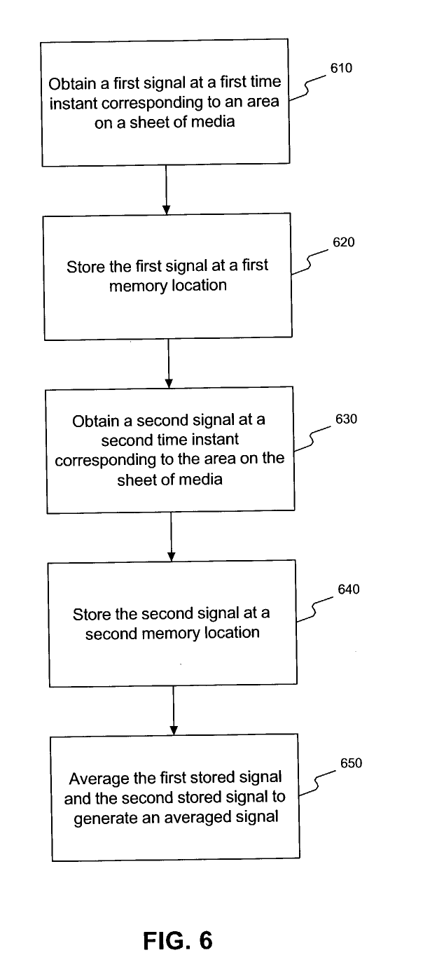

FIG. 6 shows a flowchart of an exemplary method for improving signal to noise ratio consistent with embodiments of the present invention. The method may include obtaining a first signal at a first time instant corresponding to a position on a sheet of media (step 610). In one embodiment, the first signal may be obtained using an image sensor element corresponding to a first channel for obtaining a panchromatic signal. Alternatively, the first signal may be obtained using an image sensor element corresponding to an unmasked channel for obtaining a red color signal for the media processor. Further, the first signal may be a grayscale signal corresponding to a pixel area on a sheet of media.

Next, the first signal may be stored at a first memory location (step 620). In one embodiment, the first signal may first be converted from an analog signal to a digital signal and then stored in a buffer. In another embodiment, the converted digital signal may be stored in a conventional memory.

The exemplary method may further include obtaining a second signal at a second time instant corresponding to the position on the sheet of media, wherein the second time instant is different from the first time instant (step 630). In one embodiment, the second signal may be obtained using an image sensor element corresponding to a second channel for obtaining a panchromatic signal. Alternatively, the second signal may be obtained using a channel corresponding to an unmasked channel for obtaining a blue color signal for the media processor. Further, the second signal may be a grayscale signal corresponding to a pixel area on a sheet of media.

Next, the second signal may be stored at a second memory location (step 640). In one embodiment, the second signal may first be converted from an analog signal to a digital signal and then stored in a buffer. In another embodiment, the converted digital signal may be stored in a conventional memory.

The exemplary method, as shown in FIG. 6, may further include averaging the first stored signal and the second stored signal to generate an averaged signal (step 650). In one embodiment, the first stored signal and the second stored signal may first be summed using, for example, line summing module 450 of FIG. 4B. Subsequently, using DSP 506 (FIG. 5), alone or in combination with other components of image processing system 204, the first stored signal and the second stored signal may be averaged. Of course, any other mathematical techniques may also be used for averaging the first stored signal and the second stored signal.

The method may further include obtaining a third signal at a third time instant corresponding to the position on the sheet of media, wherein the third time instant is different from both the first time instant and the second time instant. In one embodiment, the third signal may be obtained using an image sensor element corresponding to a third channel for obtaining a panchromatic signal. Alternatively, the third signal may be obtained using an image sensor element corresponding to an unmasked channel for obtaining a green color signal for the media processor. Further, the third signal may be a grayscale signal corresponding to a pixel area on a sheet of media.

The method may further include storing the third signal at a third memory location. In one embodiment, the third signal may first be converted from an analog signal to a digital signal and then stored in a buffer. In another embodiment, the converted digital signal may be stored in a conventional memory.

The exemplary method may further include obtaining a fourth signal at a fourth time instant corresponding to the position on the sheet of media, wherein the fourth time instant is different from the first time instant, the second time instant, and the third time instant. In one embodiment, the fourth signal may be obtained using an image sensor element corresponding to a channel for obtaining a grayscale signal for the media processor. Further, the fourth signal may be a grayscale signal corresponding to a pixel area on a sheet of media.

The method of claim 4 may further include storing the fourth signal at a fourth memory location. In one embodiment, the fourth signal may first be converted from an analog signal to a digital signal and then stored in a buffer. In another embodiment, the converted digital signal may be stored in a conventional memory.

In one embodiment, each of the first signal, the second signal, the third signal, and the fourth signal may be obtained using a charge coupled device sensor. Alternatively, each of the first signal, the second signal, the third signal, and the fourth signal may be obtained using a complementary metal oxide semiconductor sensor. Of course any other suitable technology may also be used to obtain each of the aforementioned signals.

Further, in one embodiment, the method may include summing the first signal, the second signal, the third signal, and the fourth signal. In one embodiment, each of the first, second, third, and fourth signals may be converted to a digital signal and then stored in a buffer, for example. Signal conversion may be achieved using analog to digital converters (for example, 332, 334, and 336 of FIG. 3). Then, in one embodiment, the first stored signal, the second stored signal, the third stored signal, and the fourth stored signal may first be summed using, for example, line summing module 450 of FIG. 4B. Subsequently, using DSP 506 (FIG. 5), alone or in combination with other components of image processing system 204, the first stored signal, the second stored signal, the third stored signal, and the fourth stored signal may be averaged.

The sheet of media may be one of a sheet of film, a sheet of paper, a sheet of transparency, or a sheet of photographic paper. In a specific embodiment, the sheet of media may be a sheet of X-ray film.

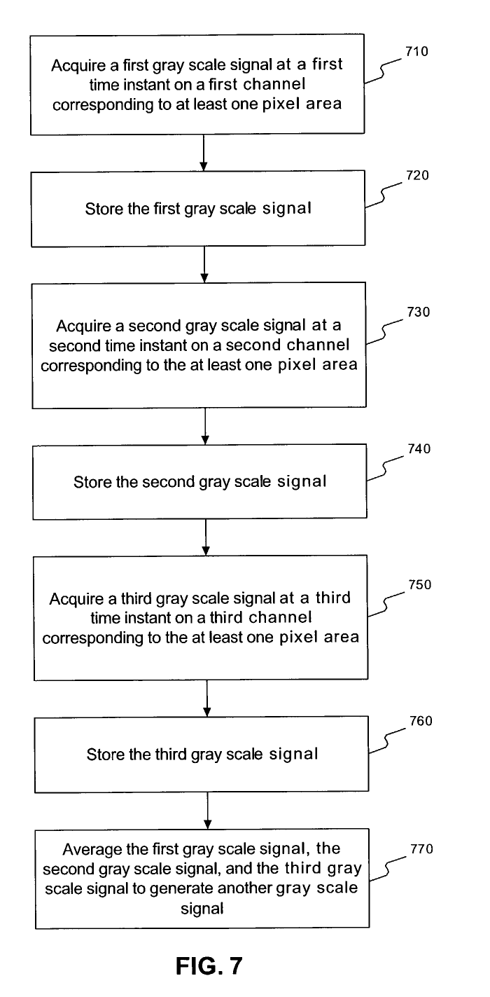

FIG. 7 shows a flowchart of another exemplary method for improving signal to noise ratio of a grayscale signal in a digitizer consistent with embodiments of the present invention. The method may include improving signal to noise ratio of a grayscale signal in a digitizer having an image sensor array comprising a first channel, a second channel, and a third channel.

The method may include acquiring a first grayscale signal at a first time instant on the first channel corresponding to at least one pixel area (step 710). The method may further include storing the first grayscale signal (step 720).

The method may further include acquiring a second grayscale signal at a second time instant on the second channel corresponding to the at least one pixel area (step 730). The method may further include storing the second grayscale signal (step 740).

Further, the method may include acquiring a third grayscale signal at a third time instant on the third corresponding to the at least one pixel area (step 750) and storing the third grayscale signal (step 760).

In one embodiment the image sensor array may be a charge coupled device sensor array. Alternatively, the image sensor array may be a complementary metal oxide semiconductor sensor array. Of course, any other suitable image sensing technology may also be used consistent with the present invention.

In one embodiment, each of the first channel, which may be for obtaining the red color signal, the second channel, which may be for obtaining the green color signal, and the third channel, which may be for obtaining the blue color signal may be unmasked to provide a grayscale signal. Alternatively, each of the channel for obtaining the red color signal, the channel for obtaining the green color signal, and the channel for obtaining the blue color signal may be filtered to provide a grayscale signal. Of course, other suitable techniques may also be used to obtain the grayscale signals.

After a signal corresponding to, for example, the intensity of a pixel area is obtained, it may be converted from an analog to a digital signal, using for example, an analog to digital converter (e.g., 332, 334, and/or 336 of FIG. 3). The digital signals may be stored in a buffer or in conventional memory.

The method may further include averaging the first grayscale signal, the second grayscale signal, and the third grayscale signal to generate another grayscale signal (step 770). In one embodiment, the method may include summing the first grayscale signal, the second grayscale signal, and the third grayscale signal. In one embodiment, the signals may first be summed using, for example, line summing module 450 of FIG. 4B. Subsequently, using DSP 506 (FIG. 5), alone or in combination with other components of image processing system 204, the first grayscale signal, the second grayscale signal, and the third grayscale signal may be averaged.

The sheet of media may be one of a sheet of film, a sheet of paper, a sheet of transparency, or a sheet of photographic paper. In a specific embodiment, the sheet of media may be a sheet of X-ray film.

Other modifications and embodiments of the invention will be apparent to those skilled in the art from consideration of the specification and practice of the invention disclosed herein. For example, although embodiments of the invention have been described herein with reference to improving the signal to noise ratio of signals obtained from a sheet of media, the invention has application in any area where the signal to noise ration may be improved.

What is claimed is:

1. A method for improving signal to noise ratio, the method comprising:
obtaining a first signal at a first time instant corresponding to a position on a sheet of media;
storing the first signal at a first memory location;
obtaining a second signal at a second time instant corresponding to the position on the sheet of media, wherein the second time instant is different from the first time instant;
storing the second signal at a second memory location; and
averaging the first stored signal and the second stored signal to generate an averaged signal.

2. The method of claim 1, further comprising:
obtaining a third signal at a third time instant corresponding to the position on the sheet of media, wherein the third time instant is different from both the first time instant and the second time instant.

3. The method of claim 2, further comprising:
storing the third signal at a third memory location.

4. The method of claim 3, further comprising:
obtaining a fourth signal at a fourth time instant corresponding to the position on the sheet of media, wherein the fourth time instant is different from the first time instant, the second time instant, and the third time instant.

5. The method of claim 4, further comprising:
storing the fourth signal at a fourth memory location.

6. The method of claim 1, wherein the first signal is a grayscale image signal.

7. The method of claim 1, wherein the second signal is a grayscale image signal.

8. The method of claim 4, wherein each of the first signal, the second signal, the third signal, and the fourth signal is obtained using a charge coupled device sensor.

9. The method of claim 4, wherein each of the first signal, the second signal, the third signal, and the fourth signal is obtained using a complementary metal oxide semiconductor sensor.

10. The method of claim 4, further comprising:
summing the first signal, the second signal, the third signal, and the fourth signal.

11. The method of claim 1, wherein the first signal corresponds to an unmasked channel for obtaining a red color signal for a media processor.

12. The method of claim 1, wherein the second signal corresponds to an unmasked channel for obtaining a blue color signal for a media processor.

13. The method of claim 2, wherein the third signal corresponds to an unmasked channel for obtaining a green color signal for a media processor.

14. The method of claim 4, wherein the fourth signal corresponds to a channel for obtaining a grayscale signal for a media processor.

15. The method of claim 1, wherein the sheet of media is one of a sheet of film, a sheet of paper, a sheet of transparency, and a sheet of photographic paper.

16. The method of claim 1, wherein the sheet of media is a sheet of X-ray film.

17. A method for improving signal to noise ratio of a grayscale signal in a digitizer having an image sensor array comprising a first channel, a second channel, and a third channel, the method comprising:
acquiring a first grayscale signal at a first time instant on the first channel corresponding to at least one pixel area;
storing the first grayscale signal;
acquiring a second grayscale signal at a second time instant on the second channel corresponding to the at least one pixel area;
storing the second grayscale signal;
acquiring a third grayscale signal at a third time instant on the third channel corresponding to the at least one pixel area;
storing the third grayscale signal; and
averaging the first grayscale signal, the second grayscale signal, and the third grayscale signal to generate another grayscale signal.

18. The method of claim 17, wherein the image sensor array is a charge coupled device sensor array.

19. The method of claim 17, wherein the image sensor array is a complementary metal oxide semiconductor sensor.

20. The method of claim 17, wherein each of the first channel, the second channel, and the third channel is unmasked to provide a grayscale signal.

21. The method of claim 17, wherein each of the first channel, the second channel, and the third channel is filtered to provide a grayscale signal.

22. The method of claim 17, wherein the sheet of media is one of a sheet of film, a sheet of paper, a sheet of transparency, and a sheet of photographic paper.

23. The method of claim 17, wherein the sheet of media is a sheet of X-ray film.

24. An apparatus for improving image quality of an image, comprising:
an image sensor array for obtaining a first grayscale signal on a red color channel, a second grayscale signal on a green color channel, and a third grayscale signal on a blue color channel corresponding to a pixel area on a sheet of media;
a first analog to digital converter for converting the first grayscale signal to a first digital value;
a second analog to digital converter for converting the second grayscale signal to a second digital value;
a third analog to digital converter for converting the third grayscale signal to a third digital value; and
a digital signal processor for averaging the first digital value, the second digital value, and the third digital value to produce an average digital value corresponding to the pixel area on the sheet of media.

25. The apparatus of claim 24, further comprising:
a line summing module for summing the first digital value, the second digital value, and the third digital value.

26. The apparatus of claim 24, wherein at least one 3×3 array of pixel areas is mapped to at least one 2×2 array of pixel areas.

27. The apparatus of claim 24, further comprising:
at least one of a SCSI controller and a USB controller.

28. The apparatus of claim 24, wherein the sheet of media is one of a sheet of film, a sheet of paper, a sheet of transparency, and a sheet of photographic paper.

29. The apparatus of claim 24, wherein the sheet of media is a sheet of X-ray film.

30. A media processor comprising:
an image processing system comprising the apparatus of claim 24;
an optical system operably coupled to the image processing system; and
a housing containing the image processing system and the optical system.

31. An apparatus for improving the image quality of an X-ray film image, the apparatus comprising:
a panchromatic sensor array for obtaining a first grayscale signal, a second grayscale signal, and a third grayscale signal corresponding to at least one pixel area on a sheet of media;
a first analog to digital converter for converting the first grayscale signal to a first digital value;
a second analog to digital converter for converting the second grayscale signal to a second digital value;
a third analog to digital converter for converting the third grayscale signal to a third digital value; and
a digital signal processor for averaging the first digital value, the second digital value, and the third digital value to produce an average digital value corresponding to the at least one pixel area on the sheet of media.
